(19) United States
(12) Patent Application Publication
(10) Pub. No.: US 2025/0227755 A1
(43) Pub. Date: Jul. 10, 2025

(54) WIRELESS COMMUNICATION METHOD, USER EQUIPMENT, AND BASE STATION

(71) Applicant: PURPLEVINE INNOVATION COMPANY LIMITED, Hong Kong (HK)

(72) Inventor: Chun-Che CHIEN, Hong Kong (HK)

(73) Assignee: PURPLEVINE INNOVATION COMPANY LIMITED, Hong Kong (HK)

(21) Appl. No.: 18/854,966

(22) PCT Filed: Apr. 8, 2023
(86) PCT No.: PCT/CN2023/087186

§ 371 Date: Oct. 7, 2024

Related U.S. Application Data
(60) Provisional application No. 63/362,721, filed on Apr. 8, 2022.

(51) Int. Cl. H04W 74/0808; H04W 72/25

(52) U.S. Cl. CPC H04W 74/0808; H04W 72/25

(57) ABSTRACT

A wireless communication method for execution by a user equipment (UE). The UE performs channel occupancy time (COT) initiating to initiate a COT based on a channel access scheme and generates COT sharing information for sharing the COT to a second UE. The UE transmits the COT sharing information in a first SL burst to the second UE. The UE receives from the second UE a second SL burst within the shared COT.

### TECHNICAL FIELD

The present disclosure relates to the field of NR sidelink evolution, and more particularly, to sidelink channel access in unlicensed band.

### BACKGROUND ART

Wireless communication systems, such as the third generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long-Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

Channel access mechanisms of New Radio in the unlicensed band (NR-U) shall be reused for sidelink unlicensed operation. The existing NR sidelink and NR-U channel structure can be reused as the baseline for NR sidelink operation over unlicensed spectrum (SL-U) while NR sidelink physical channel structures and procedures shall be changed for operating on unlicensed spectrum.

### Technical Problem

It is desirable to provide channel access configuration information for UE to access a sidelink channel in the unlicensed spectrum using Mode 1 or Mode 2 resource allocation and corresponding indication schemes.

Further study is required for Sidelink Channel Information (SCI) content, such as SCI for efficient COT sharing among UEs with different access priorities over different sidelink channels.

An efficient resource reservation scheme as well as an efficient hybrid automatic repeat request (HARQ) feedback scheme should be evaluated under the framework of LBE-based or FBE-based channel access.

### Technical Solution

An object of the present disclosure is to propose a wireless communication method, a user equipment, and a base station.

In a first aspect, an embodiment of the invention provides a wireless communication method executable in a user equipment (UE), comprising:
performing channel occupancy time (COT) initiating to initiate a COT based on a channel access scheme;
generating COT sharing information for sharing the COT to a second UE;
transmitting the COT sharing information in a first sidelink (SL) burst to the second UE;
receiving from the second UE a second SL burst within the shared COT.

In a second aspect, an embodiment of the invention provides a user equipment (UE) comprising a processor configured to call and run a computer program stored in a memory, to cause a device in which the chip is installed to execute the disclosed method and any combination of embodiments of the disclosed method.

In a third aspect, an embodiment of the invention provides a wireless communication method executable in base station, comprising:
receiving, in a first sidelink (SL) burst, COT sharing information that indicates a shared COT initiated by a first UE;
operating as a second UE for transmitting to the first UE a second sidelink (SL) burst within the shared COT.

In a fourth aspect, an embodiment of the invention provides a user equipment (UE) comprising a processor configured to call and run a computer program stored in a memory, to cause a device in which the chip is installed to execute the disclosed method and any combination of embodiments of the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, that causes a computer to execute the disclosed method.

The disclosed method may be programmed as a computer program, that causes a computer to execute the disclosed method.

The disclosed method may be implemented into a chip comprising a processor. The processor is configured to call and run a computer program stored in a memory, to cause a device in which the chip is installed to execute the method.

### Advantageous Effects

Embodiments of the disclosure provide various parameters for channel access configuration as well as operation mode indication for sidelink communication in the unlicensed spectrum.

Embodiments of the disclosure provide SCI contents for COT sharing indication and propose a corresponding operating procedure for initiator UE and responder UE.

Embodiments of the disclosure provide resource reservation and HARQ feedback schemes for unlicensed band access within or out of COT as well as corresponding a channel access procedure for initiator UE and responder UE.

Embodiments of the disclosure provide advantageous effects including:
Supporting sidelink transmission operating in unlicensed spectrum, which is crucial to improve throughput, reduce data delivery latency, and offload traffic from licensed spectrum.
Enabling more sidelink services or applications to be supported in an unlicensed band, including AR/VR gaming, direct vehicle communication, video streaming in smart home internet of things (IoT) network, etc.
Facilitating harmonization of NR-U and V2X to meet latency and reliability requirements for sidelink traffic with different priorities while taking collision avoidance into account.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field may obtain other figures according to these figures without paying the premise.

FIG. 1 illustrates a schematic view of a telecommunication system.

FIG. 2 illustrates a schematic view showing a UE-initiated COT for FBE.

FIG. 3 illustrates a schematic view showing a wireless communication method according to an embodiment of the invention.

FIG. 4 illustrates a schematic view showing a wireless communication method according to another embodiment of the invention.

FIG. 5 illustrates a schematic view showing an example of a signaling flow between a gNB and sidelink UEs.

FIG. 6 illustrates a schematic view showing an example of a procedure for determining a COT acquiring scheme.

FIG. 7 illustrates a schematic view showing an example procedure for Mode 1 resource allocation.

FIG. 8 illustrates a schematic view showing an example procedure for processing a 1st stage SCI by a receiver UE.

FIG. 9 illustrates a schematic view showing an example procedure for resource reservation scheme operating with COT sharing.

FIG. 10 illustrates a schematic view showing an example of a procedure of access a reserved resource access by an initiator UE.

FIG. 11 illustrates a schematic view showing a wireless communication method according to further another embodiment of the invention.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In the description, the terms slot if not particularly specified can be interpreted as a slot, a sub-slot, a slot location, or a sub-slot location. The terms resource if not particularly specified can be interpreted as one or more radio resources in time and frequency domains.

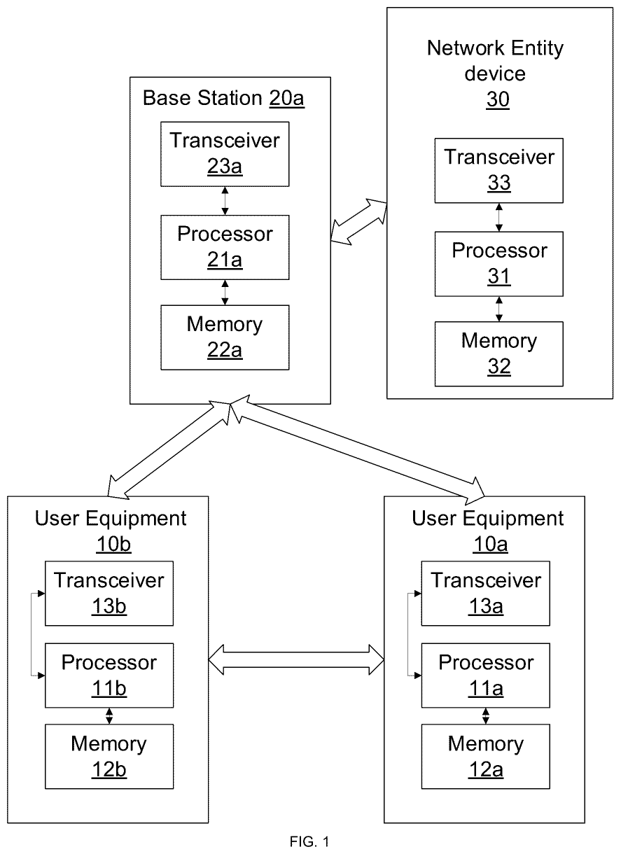

With reference to FIG. 1, a telecommunication system including a UE 10a, a UE 10b, a base station (BS) 20a, and a network entity device 30 executes the disclosed method according to an embodiment of the present disclosure. FIG. 1 is shown for illustrative not limiting, and the system may comprise more UEs, BSs, and CN entities. Connections between devices and device components are shown as lines and arrows in the FIGs. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, transmits and/or receives radio signals or wireline signals. The UE 10a may be in communication with the UE 10b through a sidelink. The base station 20a may be an eNB, a gNB, or one of other types of radio nodes, and may configure radio resources for the UE 10a and UE 10b.

Each of the processors 11a, 11b, 21a, and 31 may include an application-specific integrated circuit (ASICs), other chipsets, logic circuits and/or data processing devices. Each of the memory 12a, 12b, 22a, and 32 may include read-only memory (ROM), a random-access memory (RAM), a flash memory, a memory card, a storage medium and/or other storage devices. Each of the transceivers 13a, 13b, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

The network entity device 30 may be a node in a CN. CN may include LTE CN or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

An example of the UE(s) in the description may include one of the UE 10a or UE 10b. An example of the base station or gNB in the description may include the base station 20a. Uplink (UL) transmission of a control signal or data may be a transmission operation from a UE to a base station. Downlink (DL) transmission of a control signal or data may be a transmission operation from a base station to a UE. A DL control signal may comprise downlink control information (DCI) or a radio resource control (RRC) signal, from a base station to a UE.

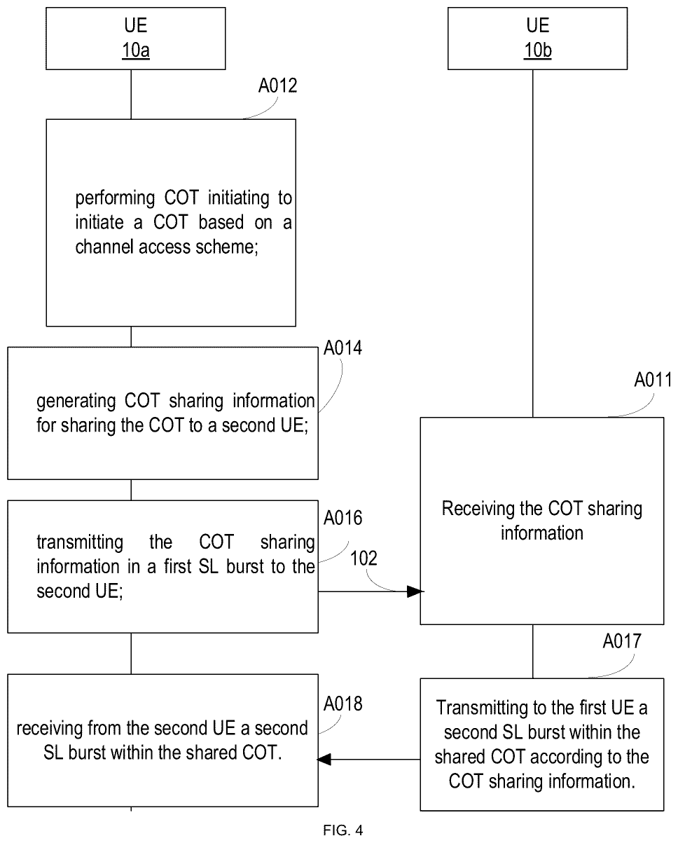

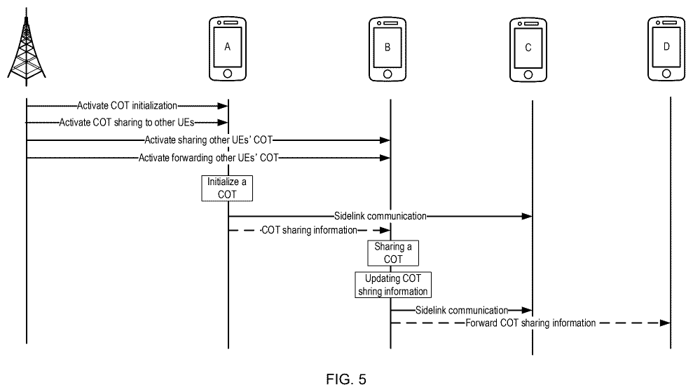

The communication between UEs may be realized according to device to device (D2D) communication or vehicle-to-everything (V2X) communication. V2X communication includes vehicle-to-vehicle (V2V), vehicle-to-pedestrian (V2P), and vehicle-to-infrastructure/network (V21/N) according to a sidelink technology developed under 3rd generation partnership project (3GPP) release 14, 15, 16, and beyond. UEs communicate with each other directly via a sidelink interface such as a PC5 interface. The disclosed method may be applied to a D2D or V2X communication. For sidelink based SPS traffic transmission on the Physical Sidelink Shared Channel (PSSCH), a transmitting side UE that sends SPS traffic scheduled by a gNB to a receiving side UE may operate similar operations as the gNB (e.g., gNB 20 in FIG. 3 or FIG. 4) in the description. The receiving side UE that receives the SPS traffic from the transmitting side UE may operate similar operations as the UE (e.g., UE 10 in FIG. 3 or FIG. 4) in the description. The receiving side UE performs HARQ feedback in response to sidelink SPS PSSCH transmission in Physical Sidelink Feedback Channel (PSFCH) based on the methods described in one or more embodiments.

In addition to increasing throughput by harvesting additional bandwidth in unlicensed spectrum, compared to NR-U with uplink and downlink operation in unlicensed spectrum, SL-U can reduce data delivery latency while offloading the traffic from licensed spectrum to unlicensed spectrum. The extensible services or applications for SL-U include direct vehicle communication, AR/VR gaming, video streaming in smart home IoT network, etc. Enhancements of channel access schemes for sidelink operation over unlicensed spectrum is necessary to meet both sidelink traffic requirements as well as regulation requirements of listen-before-talk (LBT) in the unlicensed spectrum. Functional improvements to sidelink operation comprising Mode 1 or Mode 2 resource allocation, resource reservation, and HARQ feedback under the framework of LBE-based or FBE-based channel access scheme.

NR V2X defines two resource allocation modes for sidelink communications: Mode 1 and Mode 2. Mode 1 corresponds to a centralized scheduling scheme, and Mode 2 corresponds to a distributed scheduling scheme. In mode 1, radio resources used for sidelink transmissions are scheduled by the gNB. In mode 2, UE autonomously selects radio resources from a resource pool configured by gNB before performing sidelink transmissions. Mode 1 resource allocation can only operate in scenarios where the UEs are inside the coverage of gNB. On the other hand, Mode 2 resource allocation is determined and carried out by UE, and therefore can operate either inside or outside of gNB's coverage. In NR V2X, physical sidelink control channel (PSCCH) can be used for carrying SCI, Physical Sidelink Shared Channel (PSSCH) can be used for carrying sidelink data, and Physical Sidelink Feedback Channel (PSFCH) can be used for carrying HARQ feedback information of sidelink data received in the PSSCH.

To support sidelink radio access to unlicensed bands, LBT and channel occupancy time (COT) sharing should be introduced to both Mode 1 and Mode 2 resource allocation schemes in the PC5 interface. For Mode 1 resource allocation, UE should carry out a channel access procedure, i.e., LBT, before sidelink transmission on the scheduled resources. In this case, gNB assesses a channel based on UE measurement and report and may schedule resources for sidelink UE in licensed or unlicensed spectrum of Uu interface. When scheduling resources for sidelink UE in unlicensed spectrum, gNB allocates sidelink resources in unlicensed spectrum of PC5 interface to UE. For Mode 2 resource allocation, UE should perform channel sensing, resource selection and a channel access procedure before sidelink transmission on unlicensed spectrum. In order to avoid resource collision for a shared resource pool in an unlicensed band, a reservation of sidelink resources indicated in SCI for the current or future sidelink transmission in NR-V2X can be carried over the unlicensed spectrum. Based upon the SCI, other sidelink UEs can perform SCI monitoring in the resource pool to determine whether a sidelink resource is occupied or available for sidelink transmission. After determining valid resources and performing resource selection according to a certain rule, UE may execute LBT to assess an available channel before acquiring a COT for its own sidelink transmission or share the acquired COTs with other sidelink UEs.

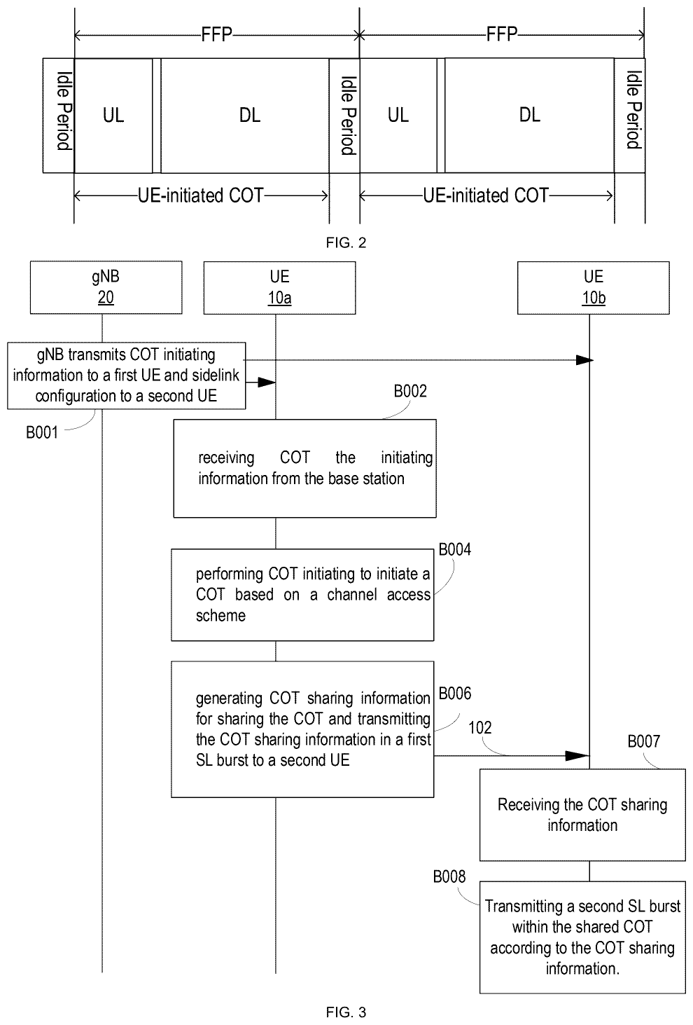

In NR-U, two channel access modes are supported, which are load-based equipment (LBE) based channel access mode and frame-based equipment (FBE) based channel access mode. LBE is also known as a dynamic channel access mode, and FBE is also known as semi-static channel access mode. In LBE channel access, a UE may perform an LBT at any time instant whenever the UE has data in the buffer and initiate a COT for transmissions upon successful LBT. On the contrary, for FBE channel access, a UE only contends for the channel based on LBT at synchronized frame boundaries. A fixed frame period (FFP) among {1 ms, 2 ms, 2.5 ms, 4 ms, 5 ms, 10 ms} is assigned for FBE devices. As shown in FIG. 2, FFP occurs periodically with a channel occupation time (COT) starting from the beginning and followed by an idle period at the end of the FFP. An indication scheme of COT sharing among UEs for PSCCH, PSSCH, or PSFCH transmission after successful LBT under the framework of LBE and FBE should be analyzed.

With reference to FIG. 3 and FIG. 4, UE 10a and UE 10b executes a wireless communication method. The gNB 20 may comprise an embodiment of the base station 20a. Note that although the gNB 20 is described as an example in the description, the wireless communication method may be executed by a base station, such as an eNB, a base station integrating an eNB and a gNB, or a base station for beyond 5G technologies.

With reference to FIG. 3, a base station, such as gNB 20, transmits COT initiating information to a first UE, such as the UE 10a, and sidelink configuration to a second UE, such as the UE 10b (B001). The first UE (e.g., UE 10a) receives the COT initiating information from the base station (e.g., gNB 20) (B002). The second UE (e.g., UE 10b) receives the sidelink configuration from the base station (e.g., gNB 20).

As illustrated in embodiments, A-1, A-2, C, and D, the COT initiating information may include information of initiating a COT based on Type 1 listen before talk (LBT) with respect to a channel access priority class (CAPC) value or a cyclic prefix extension (CPE) value. As illustrated in embodiment A-2, the CAPC value or the CPE value may be determined based on a quality identity associated with a traffic type or a channel type of a SL channel transmitted by the first UE. As illustrated in embodiments A-2 and A-4, one CAPC value or one CPE value may be pre-determined for transmission of a PSFCH channel. The COT initiating information may include information of a frequency range of Type 1 LBT for COT initiation.

As illustrated in embodiment A-3, the sidelink configuration may include information of a sidelink channel information (SCI) format of a SCI, the SCI carries COT sharing information and the SCI is transmitted in PSCCH or PSSCH.

The first UE performs COT initiating to initiate a COT based on a channel access scheme (B004). The first UE generates COT sharing information (e.g., COT sharing information 102) for sharing the COT and transmits the COT sharing information in a first SL burst to a second UE, such as UE 10b (B006).

The second UE receives the sidelink configuration from the base station and receives the COT sharing information (B007). The COT sharing information indicates a COT that is shared from the first UE. The second UE transmits a second SL burst within the shared COT according to the COT sharing information (B009).

With reference to FIG. 4, a first UE, such as the UE 10a, performs COT initiating to initiate a COT based on a channel access scheme (A012) and generates COT sharing information for sharing the COT to a second UE (e.g., UE 10b) (A014).

The first UE (e.g., UE 10a) transmits the COT sharing information (e.g., COT sharing information 102) in a first SL burst to the second UE (A016). The second UE receives, in the first SL burst, the COT sharing information and transmits to the first UE a second SL burst within the shared COT according to the COT sharing information (A017). The first UE receives from the second UE the second SL burst within the shared COT (A018).

### Embodiment A

gNB determines at least one of the following information for sidelink channel access using Mode 1 or Mode 2 resource allocation and configures or indicates corresponding parameters for a sidelink UE via downlink control information (DCI), system information message, or a radio resource control (RRC) message configuration.

### Embodiment A-1

A the gNB configures at least one of the following characteristics for a sidelink UE or activates at least one of the following functions for a sidelink UE operating in an unlicensed spectrum:
1. Activation of COT initiation for a UE;
2. Activation of COT sharing for an initiator UE;
3. Activation of a sharing function to share a COT initiated by other UE(s); and
4. Activation of direct forwarding or forwarding modified COT sharing information by a responder UE.

For example, the gNB provides an indication to indicate whether a UE can initiate a COT and/or whether the UE can use a COT initiated by other UE. The determination of one or more than one function configured or activated for a UE may rely on, e.g., UE capability, Mode 1 or Mode 2 resource allocation, in-coverage or out-of-coverage scenarios, etc.

### 1. Activation of COT Initiation for a UE:

A UE capable of initiating a COT is an initiator UE. The initiator UE can initiate a COT after applying Type 1 LBT channel access. One or more parameters used for Type 1 LBT channel access can be configured or indicated by the gNB.

More than one LBT opportunity based on LBE or FBE can be configured for an initiator UE. LBE and FBE parameters can be configured for an individual initiator UE or a group of initiator UEs.

### 2. Activation of COT Sharing for an Initiator UE:

An initiator UE can share its acquired COT with other UEs if the function of COT sharing is activated by the gNB.

Parameters for indicating COT sharing information can be carried in SCI, and the content of COT sharing information can be configured or indicated by the gNB.

One or more resource domains used for COT sharing can be configured or indicated by the gNB, including at least one of the following:

### Frequency Domain Resource:

One or more than one frequency domain resource available for COT sharing can be indicated based on bandwidth part (BWP) index, subband index, interlaced resource index, or non-interlaced resource index. The BWP stands for bandwidth part (BWP).

### Time Domain Resource:

One or more than one time domain resource location available for COT sharing within a COT can be indicated based on starting location, duration, or ending location within a COT in terms of index, length or offset value of slots or symbols with respect to a frame, a subframe, or a slot.

### 3. Activation of a Sharing Function to Share a COT Initiated by Other UE(s):

A UE capable of sharing a COT initiated by an initiator UE is a responder UE. The responder UE can share (i.e., use) the COT initiated by an initiator UE after applying one of the following channel access schemes:
Type 2C LBT (without LBT) if a transmission gap between the end of the previous sidelink transmission and the start of current sidelink transmission is at most 16 us.
   Initiator UE may transmit dummy transmission or use cyclic prefix extension (CPE) indication to ensure the transmission gap between the end of the previous sidelink transmission and the start of the current sidelink transmission is at most 16 us.
Type 2A LBT or Type 2B LBT if a transmission gap between the end of the previous sidelink transmission and the start of the current sidelink transmission is larger than 16 us or 25 us.

### 4. Activation of Direct Forwarding or Forwarding Modified COT Sharing Information by a Responder UE:

A first responder UE may directly forward COT sharing information generated by an initiator UE to a second responder UEs in case the second responder UE cannot receive the COT sharing information directly from the initiator UE.
A first responder UE may have shared part of the COT and then forward a modified COT sharing information according to the remaining available COT sharing region of the COT to the second responder UE.

The gNB may restrict any one of the aforementioned functions for a sidelink transmitter UE or a sidelink receiver UE based on at least one of the following criteria, and the sidelink transmitter UE or the sidelink receiver UE may be pre-configured or by default activated with any one of the aforementioned functions according to at least one or combinations of the following criteria:
Sidelink UE capability reported by the UE.
Sidelink UE scheduling assistance information reported by the UE.
   For example, the sidelink UE scheduling assistance information may comprise sidelink traffic type, latency requirement, periodicity, time offset, message size, quality of service (QoS) info, etc., and can be included in a reporting message.
A UE role that indicates the sidelink UE is a transmitter UE or a receiver UE.
A status showing that the sidelink UE is operated in-coverage of the gNB or out-of-coverage of the gNB. For example, the status may show that:
   The initiator UE can only operate in the coverage of the gNB;
   The responder UE can operate either in-coverage or out-of-coverage of the gNB; or
   The responder UE can forward COT sharing information when operating in the coverage of the gNB.
An event in which a sidelink transmission involving the UE is scheduled based on Mode 1 resource allocation or Mode 2 resource allocation.
An event in which a sidelink transmission involving the UE is scheduled based on configured grant (CG) scheduling or dynamic grant (DG) scheduling.
An event in which a sidelink transmission involving the UE is scheduled based on Type1 SL CG or Type 2 SL CG.
An event in which a sidelink transmission involving the UE is scheduled for initial sidelink transmission or re-transmission.
An event in which a sidelink transmission involving the UE is scheduled with or without HARQ feedback.

With reference to FIG. 3, as illustrated in embodiments, A-1, A-2, C, and D, the COT initiating information may include information of initiating a COT based on Type 1 listen before talk (LBT) with respect to a channel access priority class (CAPC) value or a cyclic prefix extension (CPE) value.

FIG. 5 illustrates an example of a signaling flow to demonstrate operation roles between the gNB and sidelink UEs.

### Embodiment A-2

The gNB configures at least one of the following parameters for a sidelink transmitter UE to initiate a COT.
1. Whether UE can initiate a COT according to LBE-based channel access scheme, FBE-based channel access scheme, or both;
2. Channel access priority class (CAPC) for Type 1 LBT (i.e., Category 4 LBT) for LBE-based sidelink communication;
3. FFP parameters configured for sidelink UE for FBE-based sidelink communication:
4. Transmission power control:
5. Energy detection (ED) threshold;
6. CPE length;
7. Frequency domain resource allocation or configuration for sidelink transmission;
8. Time domain resource allocation or configuration for sidelink transmission; PSCCH resource location configuration; and
9. PSCCH resource location configuration.

1. Whether UE can initiate a COT according to LBE-based channel access scheme, FBE-based channel access scheme, or both;
The gNB may configure the parameter in a per-UE or per group of UEs configuration.
For a UE capable of both LBE-based channel access scheme and FBE-based channel access schemes, if the UE operates as an initiator UE and fails in LBT based on either one of FBE-based or LBE-based COT initiation, the UE can initiate the COT based on the other one of FBE-based channel access scheme or LBE-based channel access scheme.

2. Channel access priority class (CAPC) for Type 1 LBT (i.e., Category 4 LBT) for LBE-based sidelink communication:
Different LBT priority classes are defined with different contention window sizes (CWS) and maximum channel occupancy time (MCOT).
CAPC for a sidelink transmission involving the UE can be determined by the gNB based on one or more of:
   Scheduling assistance information reported by UE, such as Latency requirement, periodicity, time offset, message size, QoS info, etc;
   A traffic type or priority level reported by UE, such as QoS profile of the radio bearer with a quality class identifier (QCI) or a logical channel prioritization (LCP) associated with a data radio bearer (DRB); and
   A channel type or content of the sidelink communication, such as PSCCH or PSFCH has higher CAPC priority.

3. FFP parameters configured for sidelink UE for FBE-based sidelink communication:
The FFP parameters may include one or more of an FFP period, an FFP offset, and IDLE period location within an FFP.
   The FFP period values can be configured to a value of {1, 2, 2.5, 4, 5, 10} milliseconds (ms).
   The FFP offset value is relative to a frame boundary.
One or more than one set of FFP {period and offset} values for a sidelink UE can be configured by the gNB.
   The gNB can select and indicate one set of FFP parameters to the UE according to the traffic type or QoS information reported by the UE.
   Alternatively, the UE can determine one set of FFP parameters according to its own traffic type or QoS information.

4. Transmission power control:
The UE transmits sidelink data according to a configured maximum transmission power applied to the channel access procedure for sidelink transmission. The transmission power control parameter may indicate the configured maximum transmission power of the UE.

5. Energy detection (ED) threshold:
A UE uses an ED threshold to compare the measured energy with a threshold value of the ED threshold to decide whether the channel is available. The UE can determine an ED threshold based on a configured ED threshold or calculate an ED threshold based on UE's configured maximum transmission power.
A value of energy detection threshold for channel access may depend on whether the UE can share the acquired COT to other UEs or not.
   For sidelink COT sharing case, an ED threshold parameter, e.g., SL-toSL-CO-SharingED-Threshold (similar to UL-toDL-CO-SharingED-Threshold in NR), can be configured by the gNB for a UE to perform channel access. The UE then shares an initiated COT with another UE. For example, a transmitter UE can initiate a COT based on an ED threshold and transmit a PSSCH/PSCCH to a receiver UE. Using the COT to transmit PSSCH and/or PSCCH may be referred to as forward COT sharing. The receiver UE can share the COT and transmit HARQ feedback associated with the received PSSCH in PSFCH to the transmitter UE. Using the COT to transmit PSFCH may be referred to as backward COT sharing.
   If SL-toSL-CO-SharingED-Threshold is provided, the sidelink receiver UE that shares the COT at least can transmit unicast sidelink data to the transmitter UE that initiates the COT.
   If SL-toSL-CO-SharingED-Threshold is not provided, the sidelink receiver UE that shares the COT can transmit non-unicast sidelink data (e.g., broadcast information, such as sidelink synchronization signal, S-SS) to other UEs.

6. CPE length:
CPE length indicated by the CPE length parameter can be used to prioritize sidelink transmission based on a starting point adjustment of a sidelink transmission opportunity.
   For example, a longer CPE length leads to earlier transmission.
   A CPE length can be indicated based on the priority of the traffic type or the SL channel type transmitted by the UE. For example, Ex: HARQ feedback in PSFCH has a higher priority.
Alternatively, the gNB can assign a group of CPE candidates, and the UE can determine which one to be selected according to the priority of the UE or UE's processing time.

7. Frequency domain resource allocation or configuration for sidelink transmission: The frequency domain resource allocation or configuration for sidelink transmission may include one or more of:
A per-BWP resource indication;
A sub-band location indication for LBT within a BWP; and
An interlaced or non-interlaced resource allocation with resource block (RB) granularity.
   Each of the interlaced/non-interlaced resources with RB granularity corresponds to an interlaced/non-interlaced resource index.
   One or more than one interlaced index for sidelink communication can be indicated by the gNB for the same transport block (TB) or different TBs.
   For PSSCH transmission, one or more than one interlaced/non-interlaced resource with the indicated index(es) can carry one TB or more than one TB.
   For PSCCH transmission, PSCCH resource location is preconfigured by gNB and can be indicated based on an interlaced/non-interlaced resource index or an RB index within an interlaced/non-interlaced resource.

8. Time domain resource allocation or configuration for sidelink transmission: The time domain resource allocation or configuration for sidelink transmission may comprise:
A per-BWP resource indication.
An indication that indicates an LBT starting point or a sidelink transmission starting point.
   The LBT starting point or sidelink transmission starting point can be indicated using an offset value with respect to a frame, slot boundary, or ending slot of DCI received by the UE.
   The starting point of sidelink transmission can be further determined based on a CPE length.
   One or more than one sidelink transmission starting point or length for the same or different TBs can be indicated by the gNB using a time-domain resource allocation (TDRA) table.
   For LBE-based channel access, one or more than one starting point for LBT can be indicated by the gNB.
      Each starting point for LBT can be indicated as an LBT opportunity based on periodicity.
      Each starting point for LBT can be indicated by a gap period between consecutive LBT opportunities.
   For FBE-based channel access, a fixed LBT location according to FFP parameter(s) can be configured by the gNB.
More than one sidelink resource for the same or different TBs over more than one continuous sidelink transmissions. The more than one continuous sidelink transmissions comprises:
   Continuous sidelink transmissions for repetitions of one single TB within a COT or across COTs.
   Continuous sidelink transmissions for different TBs within a COT or across COTs.
      Each of the TB is associated with a corresponding HARQ ID, new data indication (NDI), or redundancy version (RV).

9. PSCCH resource location configuration:
The PSCCH resource location configuration can include one or more of:
   PSCCH period configuration (e.g., Ex: Slot-based or subslot-based monitoring period for receiver UE);
   PSCCH orthogonal frequency division multiplexing (OFDM) symbol number configuration; and
   PSCCH search space configuration and control channel element (CCE) aggregation level configuration.

With reference to FIG. 3, as illustrated in embodiments A-2, the CAPC value or the CPE value may be determined based on a quality identity associated with a traffic type or a channel type of a SL channel transmitted by the first UE. The second UE may transmit the second SL burst according to a CPE value within the shared COT. The CPE value is determined based a quality identity associated with a traffic type, or a channel type of a SL channel in the second SL burst transmitted by the second UE.

With reference to FIG. 3, as illustrated in embodiments A-2, the frequency range may include at least one of subband indexes within a SL bandwidth part (BWP). The COT initiating information may include information of a time domain location for performing Type 1 LBT to initiate a COT. The time domain location may include more than one starting position within a slot for the first sidelink burst transmission.

With reference to FIG. 3, as illustrated in embodiments A-2, a resource location may be configured by the base station for the PSCCH. The resource location of PSCCH may include occurrence periodicity and symbol length of the PSCCH. The resource location of PSCCH may include more than one starting position within a slot for transmission of PSCCH in the first sidelink burst. The more than one starting point per bandwidth part may be pre-configured by the base station.

With reference to FIG. 3, as illustrated in embodiments A-2, the first SL burst or the second SL burst may include more than one SL transmissions, each one of the SL transmissions corresponds to the same transport block (TB) or different TBs.

With reference to FIG. 3, as illustrated in embodiments A-2, the sidelink configuration may include more than one starting position for PSCCH monitoring within a slot. The more than one starting position may be configured per bandwidth part.

With reference to FIG. 3, as illustrated in embodiments A-2, the sidelink configuration includes symbol length of PSCCH.

With reference to FIG. 4, as illustrated in embodiment A-2, the channel access scheme may be a Type 1 channel access with respect to a channel access priority class (CAPC) value or a cyclic prefix extension (CPE) value, the Type 1 channel access is operated for one of more than one starting position of the first SL burst transmission within a slot. The location of the more than one starting position may be pre-configured per SL BWP.

With reference to FIG. 4, as illustrated in embodiment A-2, more than one CAPC value may be pre-configured for the first UE, and one of the more than one CAPC value is selected by the first UE according to a quality identifier of a traffic type or the type of a SL channel transmitted by the first UE. One CAPC value may be pre-determined for PSFCH transmission by the first UE.

With reference to FIG. 4, as illustrated in embodiment A-2, more than one CPE value may be pre-configured for the first UE, and one of more than one CPE value is selected by the first UE to adjust a starting point for transmitting the first SL burst, and the selection of the CPE value is based on a priority level of a traffic type or the type of a SL channel transmitted by the first UE. One CPE value is pre-determined for PSFCH transmission by the first UE.

With reference to FIG. 4, as illustrated in embodiment A-2, the first UE performs the Type 1 channel access within a sub-band with resource block (RB) granularity in a SL bandwidth part (BWP).

### Embodiment A-3

The gNB configures at least one of the following parameters for a sidelink UE that shares other UEs' COT (i.e., responder UE):
1. A supported channel access type while sharing a COT;
2. A parameter for COT sharing information detection in SCI;
3. Supported transmission targets for responder UE that shares other UE's COT;
4. A supported sidelink channel for COT sharing;
5. An indication of LBE-based or FBE-based COT sharing scheme;
6. Capability of forwarding COT sharing information to other UEs; and
7. An indication of PSCCH monitoring.

1. A supported channel access type while sharing a COT, e.g., Type 2A, Type 2B, or Type 2C.
The supported channel access type may be Type 2C LBT (without LBT) if transmission gap is at most 16 us.
   The initiator UE may transmit dummy transmission or use CPE indication to ensure that the transmission gap is at most 16 us.
The supported channel access type may be Type 2A LBT or Type 2B LBT if the transmission gap is larger than 16 us or 25 us.

2. A parameter for COT sharing information detection in SCI, e.g.,
As SCI format with COT sharing information;
PSCCH monitoring periodicity for SCI with COT sharing information; and/or
Whether a COT sharing information field in SCI is configured by the gNB.

3. Supported transmission targets for responder UE that shares other UE's COT: For example, the parameter of supported transmission targets may show that:
Shared COT can be used for a unicast transmission to any UE or only to the UE that has initiated the COT;
Shared COT can be used for a groupcast transmission to any group of UEs or to the group at least includes the UE that has initiated the COT; and/or
Shared COT can be used for a broadcast transmission to all UEs.

4. A supported sidelink channel for COT sharing: For example, the parameter of a supported sidelink channel for COT sharing may show that:
No restriction, i.e., a shared COT can be used for any sidelink channel or sidelink signal;
A shared COT can be used for one or more than one sidelink channel type, i.e., PSCCH, PSSCH, PSFCH, and/or PSBCH; or
A shared COT can be used for only one or more than one sidelink signal type, i.e., S-PSS, S-SSS, PT-RS, CSI-RS. The S-PSS, S-SSS, PT-RS, CSI-RS respectively stand for Sidelink Primary Synchronization Signal (S-PSS), S-Secondary Synchronization Signal (S-SSS), phase tracking reference signal (PT-RS), channel state information reference signal (CSI-RS).

5. An indication of LBE-based or FBE-based COT sharing scheme:
For FBE-based channel access,
   Information of FFP parameters of one or more than one other UE includes periodicity and offset. The information can be indicated to the UE capable of sharing other UE's COT.
      A responder UE can determine COT sharing information based on the FFP parameters.
      A responder UE can detect COT sharing information in SCI transmitted by the UE that initiates the COT.
For LBE-based channel access,
   A responder UE can detect COT sharing information in SCI transmitted by the UE that initiates the COT.

6. Capability of forwarding COT sharing information to other UEs:
A responder UE can forward COT sharing information to other UEs if configured by the gNB or indicated in the received SCI.

7. An indication of PSCCH monitoring: The indication of PSCCH monitoring may comprise:
A PSCCH monitoring period, e.g., a slot-based or subslot-based PSCCH monitoring period;
Search space configuration of PSCCH; and/or
An aggregation level of PSCCH.

With reference to FIG. 3, as illustrated in embodiment A-3, the COT sharing information may be transmitted using a sidelink channel information (SCI) format of a SCI. The SCI can be carried in the physical sidelink control channel (PSCCH) or physical sidelink shared channel (PSSCH). The SCI may include a field for carrying the COT sharing information.

With reference to FIG. 3, as illustrated in embodiment A-3, the sidelink configuration may include information of a sidelink channel information (SCI) format of a SCI, the SCI carries COT sharing information and the SCI is transmitted in PSCCH or PSSCH. The sidelink configuration may include a monitoring period for PSCCH monitoring. The sidelink configuration may include a frequency range for PSCCH monitoring. The frequency range may include at least one of subband indexes within a SL bandwidth part (BWP).

With reference to FIG. 3, as illustrated in embodiment A-3, the COT sharing information may include a set of fixed frame period (FFP) parameters associated with the first UE. The set of FFP parameters may include an FFP period and an FFP offset relative to a frame boundary.

With reference to FIG. 4, as illustrated in embodiment A-3, a LBT type determined based on type of SL channel in the second SL burst or width of transmission gap before the second SL burst can be used by the second UE to perform channel access for transmitting the second SL burst within the shared COT; wherein the specific LBT type includes Type 2A, Type 2B, or Type 2C.

With reference to FIG. 4, as illustrated in embodiment A-3, the COT sharing information is carried in a transmission of sidelink channel information (SCI) with a preconfigured SCI format.

With reference to FIG. 4, as illustrated in embodiment A-3, the COT sharing information includes a COT forwarding information to indicate whether the second UE is allowed to forward the COT sharing information to a third UE.

### Embodiment A-4

The gNB configures one or more of the following parameters for a sidelink UE that shares COT to other UEs (i.e., initiator UE):
1. A defined or configured SCI format supporting COT sharing information in PSCCH; and
2. COT sharing configuration.

1. A defined or configured SCI format supporting COT sharing information in PSCCH:
The SCI format includes a COT sharing information field in SCI.
The SCI format has a bit length in the COT sharing information field.

2. COT sharing configuration: The COT sharing configuration comprise time domain COT sharing indication and frequency domain COT sharing indication.
Time domain COT sharing indication:
   For sidelink UE capable of COT sharing, e.g., shown by a capability reported by the sidelink UE, the sidelink UE can be configured with a set of COT sharing parameters, e.g., SL-COT-SharingList similar to cg-COT-SharingList in NR, in terms of a table configured by the gNB.
      Each row of the table provides a record of COT sharing information, including a starting point (e.g., located based on an offset from the end of the symbol or slot where SCI is received, or a gap from the end of the symbol or slot where sidelink burst transmitted from an initiator UE is ended), ending point, or time duration for COT sharing.
      An initiator UE selects a row index of a row in the table which comprises a record of COT sharing information and transmits the COT sharing information in the SCI to a responder UE for the responder UE to acquire the information of an available sharing area in the COT.
      One row of the table can be configured to indicate whether sidelink COT sharing is allowed or not allowed.
Frequency domain COT sharing indication:
   For sidelink UE capable of COT sharing, e.g., shown by a capability reported by the sidelink UE, one or more of the following parameters can be indicated by the initiator UE in the SCI for the responder UE to acquire the information of an available frequency range shared in the COT:
      A BWP index;
      An interlace index, RB index, or subband index;
      A number of continuous interlaces, RBs, or subbands; and
      Ending of an interlace index, RB index, or subband index.

The gNB may configure one or more of the following fields in the SCI for indicating COT sharing information in the PSCCH:
A COT sharing information field: similar to DCI format 2_0 (the gNB shares COT to UE) or CG-UCI (UE shares COT to the gNB). CG-UCI stands for configured grant uplink control information (CG-UCI). The number of bits, i.e., bit width, of the COT sharing information field in the SCI can be configured by the gNB. At least one of following information can be carried in this field.
   An indication that shows allowance of COT sharing:
      The indication notifies a receiver UE whether sidelink COT sharing is allowed or not. The receiver can conduct sidelink COT sharing according to the indication. Specifically, receiver can conduct sidelink COT sharing to use a COT initiated by one of other UEs when the indication shows that sidelink COT sharing is allowed. The receiver UE can be prohibited to conduct sidelink COT sharing and refrain from using a COT initiated by one of other UEs when the indication shows that sidelink COT sharing is not allowed.
   A time domain and/or frequency domain indication:
      If sidelink COT sharing is enabled, a field may indicate a starting time, ending time, and/or duration of a shared COT.
A channel access scheme field that indicates a channel access scheme:
   For FBE-based channel access, the gNB may configure one or more of the following fields in the SCI:
      An LBT indication, including an LBT type, CPE length or CAPC for sharing a resource within a COT.
      An indication of whether a UE receiving a scheduled SL transmission from a transmitter UE can only share the COT initialized by the transmitter UE or can also initialize its own COT based on its FFP parameter. For example, for SL channel with low latency requirement, e.g., PSFCH responding the received PSSCH, a new COT can be initiated by a receiver UE.
         An indication for a UE to either share a transmitter UE's COT or initialize its own COT for an SL transmission scheduled by the transmitter UE can be joint encoded in the same field of LBE-based channel access.
         For a receiver UE capable of initiating its own COT:
         If the receiver UE intends to initiate its own COT, the receiver UE can use a FFP parameter indicated in the received SCI. For example, the FFP parameter can the same as or different to the FFP parameters used by the transmitter UE.
         Parameters defined in Embodiment A-1 can be transmitted in the SCI by a transmitter UE to a receiver UE which is capable of initializing its own COT. For example, the parameters may comprise:
         An energy detection threshold;
         A transmission power; and/or
         An LBT indication, including LBT type, CPE length or CAPC.
   For LBE-based channel access, the gNB may configure one or more of the following fields in the SCI:
      An LBT indication, including LBT type, CPE length or CAPC for sharing a resource within a COT.
         An LBT type, CPE length or CAPC can be indicated based on the priority of the traffic type or SL channel type transmitted by a responder UE.
         For example, HARQ feedback in PSFCH has a higher priority.

With reference to FIG. 3, as illustrated in embodiments A-2 and A-4, one CAPC value or one CPE value may be pre-determined for transmission of a PSFCH channel within the shared COT. The COT initiating information may include information of a frequency range of Type 1 LBT for COT initiation.

With reference to FIG. 3, as illustrated in embodiment A-4, the COT initiating information may include a COT sharing configuration. The COT sharing configuration may include a list of multiple time-domain or frequency-domain regions from which one time-domain or frequency-domain region may be selected by the first UE, and the first UE indicates the selected time-domain or frequency-domain region in the COT sharing information. The sidelink configuration may include a list of multiple time-domain or frequency-domain regions from which one time-domain or frequency-domain region may be selected by the first UE, and the first UE indicates the selected time-domain or frequency-domain region in the COT sharing information.

With reference to FIG. 3, as illustrated in embodiment A-4, the COT sharing configuration may include row indexes of a table to indicate each one of the multiple time-domain or frequency-domain regions. One of the indexes indicates that COT sharing is not allowed. The sidelink configuration may include row indexes of a table to indicate each one of the multiple time-domain or frequency-domain regions. One of the indexes indicates that COT sharing is not allowed.

With reference to FIG. 3, as illustrated in embodiment A-4, the SCI may include a field for indicating a channel access scheme for the second UE to perform LBT within the shared COT. The channel access scheme may include a LBT type or a CPE value.

With reference to FIG. 3, as illustrated in embodiment A-4, the SCI in the sidelink configuration may include a field for indicating a channel access scheme for the second UE to perform LBT within a shared COT. The channel access scheme includes a LBT type or a CPE value.

With reference to FIG. 4, as illustrated in embodiment A-4, the COT sharing information may include a time domain COT sharing indication to indicate an index for one set of COT parameters among multiple sets of COT parameters for COT sharing, the set of COT parameters includes at least a starting point for COT sharing, wherein the starting point for COT sharing is relative to an ending symbol or ending slot carrying the SCI within the COT.

With reference to FIG. 4, as illustrated in embodiment A-4, the COT sharing information includes a frequency domain COT sharing indication to indicate a range of frequency domain resources for COT sharing in terms of BWP index, sub-band index, or RB index.

With reference to FIG. 4, as illustrated in embodiment A-4, the SCI may include channel access scheme information of CAPC, LBT type, or CPE length for the second UE to perform LBT in the shared COT.

### Embodiment A-5

For a UE capable of acting as both initiator UE (initiate a COT) and responder UE (sharing other UE's COT) based on the gNB configuration or an indication indicated via SCI or DCI, the following applies.
For a UE having detected a COT sharing information transmitted from a transmitter UE and the COT sharing is allowed. Upon sidelink traffic arrival at the UE, the UE can determine to initiate a COT or share (i.e., use) a COT initiated by one of other UEs based on at least one of the following schemes:
   Based on a predetermined rule: For example,
      Sharing a COT is by default prioritized over initiating a COT.
      The determination is based on a sidelink channel type or signaling type:
         For example, HARQ feedback in PSFCH is by default transmitted using shared COT.
      The determination is based on LBT result, the earliest available LBT opportunity or the earliest available resource. For example,
         If COT initialization is prioritized over sharing COT, but UE fails to initialize a COT due to LBT failure, then UE can share a COT from other UEs.
         If an LBT opportunity for COT initialization is earlier than a COT for COT sharing, then COT initialization is determined by UE.
         If the earliest available resource for SL transmission is based on COT sharing, then the UE determines to use COT sharing.
   Based on the gNB configuration:
      For example, sharing a COT is configured to be prioritized over initiating a COT.
   Based on a dynamic indication in DCI or SC:
      For example, a dynamic indication received by the UE can overwrite the priority order pre-configured by the gNB.
   Autonomous determination by the UE, e.g.,
      For example, based on a traffic type, such QoS, latency requirement, etc., the UE determines to initiate a COT or share (i.e., use) a COT initiated by one of other UEs.
Above determination criteria between COT initiation and COT sharing can be analogously applied as determination criteria between LBE-based or FBE-based channel access scheme.
   For a UE supporting both LBE-based channel access scheme and FBE-based channel access scheme, either LBE or FBE is adopted can be based on
      A predetermined rule;
      The gNB configuration;
      A dynamic indication in DCI or SCI;
      Autonomous determination by the UE
   For a UE capable of both LBE-based channel access scheme and FBE-based channel access scheme, if the initiator UE fails in LBT based on either one of FBE-based or LBE-based COT initiation, the UE can initiate the COT based on the other channel access scheme.
   Similarly, for a UE capable of LBE-based channel access scheme and FBE-based channel access scheme, if the responder UE fails in LBT based on either one of FBE-based or LBE-based COT sharing, the UE can share the COT based on the other channel access scheme.

### Embodiment A-6

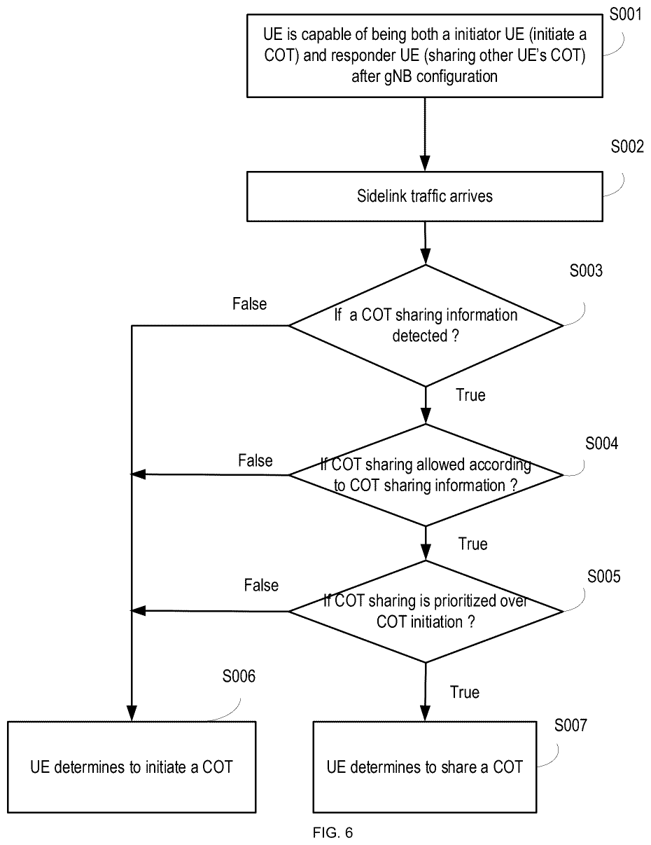

With reference to FIG. 6, in the following is an example procedure in Embodiment A-5 for determining an SL transmission on an initiated COT or on a shared COT.
A UE is configured or indicated by the gNB to support both functions of COT initiating and COT sharing (S001).
Sidelink traffic arrives at the UE, and the UE is prepared for SL transmission (S002).
The UE determines whether the UE has detected a piece of COT sharing information transmitted from an initiator UE. If false, go to S006; otherwise, proceed to S004 (S003).
The UE determines whether COT sharing is allowed according to the detected COT sharing information. If false, go to S006; otherwise, proceed to S005 (S004).
The UE determines the priority order of COT sharing and COT initiating based on the Embodiment in A-5. If COT sharing is prioritized over COT initiating, then go to S007; otherwise, go to S006 (S005).
The UE determines to initiate a COT (S006).
The UE determines to share a COT initiated by one of other UEs (S007).

### Embodiment B

Resource scheduling schemes for a the gNB scheduling an SL transmission based on Mode 1 resource allocation are detailed in the following.
The gNB schedules a UE responsible for initiating a COT using, e.g., Type 1 LBT, channel access.
   The UE can report a LBT result during COT initiating to the gNB, or
   The gNB can determine whether the COT has been initiated by the UE according to detection of COT sharing information or channel sensing results.
   If the gNB determines the COT has been successfully initiated, the gNB can proceed to schedule a resource within the COT for another UE based on Mode 1 resource allocation.
The gNB schedules a resource for a UE that shares a COT initiated by an initiator UE.
   The gNB can indicate to the UE an LBT type, e.g., Type 2A/2B/2C, or CPE length for channel access within a COT.
The search space or DCI format used for the gNB to schedule an SL transmission out of COT (for COT initiation) or within a COT (for COT sharing) can be the same or different.
The gNB can provide scheduling information for both of COT initiating and COT sharing cases, and UE can determine a channel access scheme of Type 1 LBT or Type 2 LBT depending on a COT acquiring scheme which is one of the COT initiating or the COT sharing.
If the Uu interface is also under an unlicensed spectrum, the gNB can share its own COT to the scheduled SL UE after successful LBT or transmit an indication the scheduled SL UE to have the scheduled SL UE initiate its own COT.

With reference to FIG. 3, as illustrated in embodiment B, the first UE may report a COT initiation result to the base station.

### Embodiment B-1

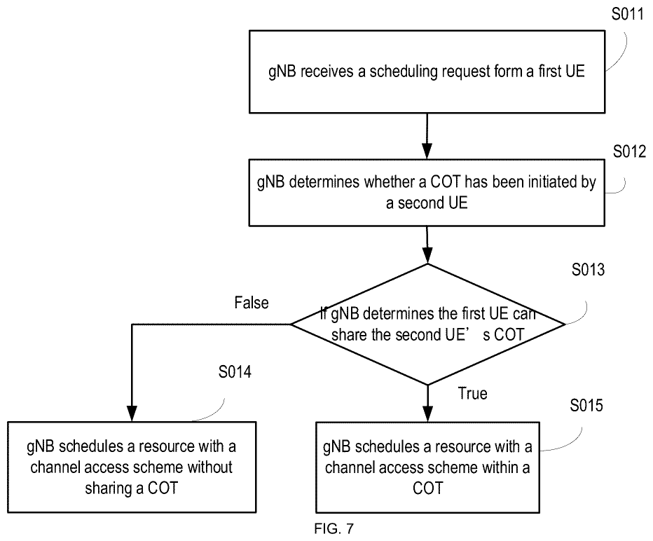

With reference to FIG. 7, an example procedure for Mode 1 resource allocation is provided in the following.
The gNB receives a scheduling request from a first UE for scheduling a resource for SL transmission (S011).
The gNB determines whether a COT has been initiated by a second UE (S012).
If the gNB determines that a COT has been initiated by a second UE and the first UE can use a COT initiated by the second UE, then the gNB schedules a sidelink resource for the first UE according to a channel access scheme within the initiated COT (S015); otherwise, the gNB schedules a sidelink resource for the first UE according to a channel access scheme not within an initiated COT. Since the first UE does not use any initiated COT (S014), the first UE need to initiate a COT before accessing the scheduled resource.

### Embodiment C

SCI transmission schemes for an initiator UE to share its COT to other UEs are provided in the following.

Two-stage SCI indication is supported for unlicensed spectrum:
For the 1^{st} stage SCI: In addition to resource reservation information of current and future transmissions, at least one of the following parameters can be transmitted by a transmitter UE in the 1^{st} stage SCI on PSCCH for sensing or detecting by other UEs:
   COT sharing information as indicated in Embodiment A-4.
   A channel access scheme: The channel access scheme may comprise one or more of the following.
      A channel access scheme for another UE to share a COT based on LBE or FBE as indicated in Embodiment A-4.
      A channel access scheme for another UE to initiate a COT based on LBE or FBE as indicated in Embodiments A-2 and A-4.
         Regarding the channel access scheme in SCI in Embodiment A-6 to determine whether a receiver UE can initiate its own COT, the receiver UE may initiate its own COT, even within a COT of an initiator UE, for SL transmission in one of the following conditions:
         The initiator UE does not allow the receiver UE to share a COT.
         The initiator UE transmits an indication to the receiver UE, and the indication requests the receiver UE to initiate its own COT.
         The resource scheduled for the receiver UE is outside of the initiator UE's COT.
      A channel access scheme indicated in SCI can overwrite a default channel access scheme, RRC configured channel access scheme, or the channel access scheme indicated by the gNB using DCI.
   FFP parameters:
      For FBE-based channel access, an FFP parameter adopted by an initiator UE can be carried in the 1^{st} stage SCI for another UE to determine a COT region of an initiated COT.
   A priority level indication:
      The priority level indication provides a restriction to COT sharing. According to the restriction, only those UEs having priority levels higher than a priority level given by the priority level indication can use a shared COT initiated by an initiator UE.
   Target UE restriction for receiving data in a shared COT:
      For a responder UE that shares a COT initiated by an initiator UE, when selecting a target UE and transmitting data to the target UE, the responder UE may have restrictions on the selection of target UE. The qualified target UE for the responder UE to schedule a sidelink resource within the shared COT can be indicated based on:
         A destination UE identifier or a source UE identifier, or
         A COT sharing identifier for a specific group of UEs.
For the 2^{st} state SCI: the following information can be carried in the PSSCH.
   An HARQ process ID, NDI (new data indicator), and/or RV (redundancy version)
   One or more of the parameters indicated in the 1^{st} stage SCI.

With reference to FIG. 3, as illustrated in embodiments A-2 and C, the COT initiating information may include an indication of a set of fixed frame period (FFP) parameters for frame-based equipment (FBE) based SL transmission. The set of FFP parameters includes an FFP period and an FFP offset relative to a frame boundary. More than one set of FFP parameters may be configured by the base station, the first UE may determine a selected set of FFP parameters based on a quality indication with respect to a traffic type or a channel type of a SL channel transmitted by the first UE. The sidelink configuration may include a set of FFP parameters. The set of FFP parameters may include an FFP period and an FFP offset relative to a frame boundary.

With reference to FIG. 3, as illustrated in embodiments A-2 and C, the COT sharing information may include a FFP parameter adopted by the first UE.

With reference to FIG. 4, as illustrated in embodiment C, at least part of the COT sharing information is transmitted in the physical sidelink shared channel (PSSCH).

With reference to FIG. 4, as illustrated in embodiment C, the COT sharing information may include information regarding whether one or more than one receiver UE is a qualified UE to use the shared COT.

With reference to FIG. 4, as illustrated in embodiment C, the COT sharing information may include UE identity information, and the UE identity information may include information of one or more than one qualified UE for using the shared COT. The UE identity information may include a source ID that represents the first UE initiating the COT, a destination ID that represents one or more than one target UE of the first UE initiating the COT, or an ID indicating at least one qualified UE.

With reference to FIG. 4, as illustrated in embodiment C, the COT sharing information includes an initiator indication to indicate whether the second UE shall initiate its own COT or use the first UE's COT for the second SL burst transmission.

### Embodiment C-1

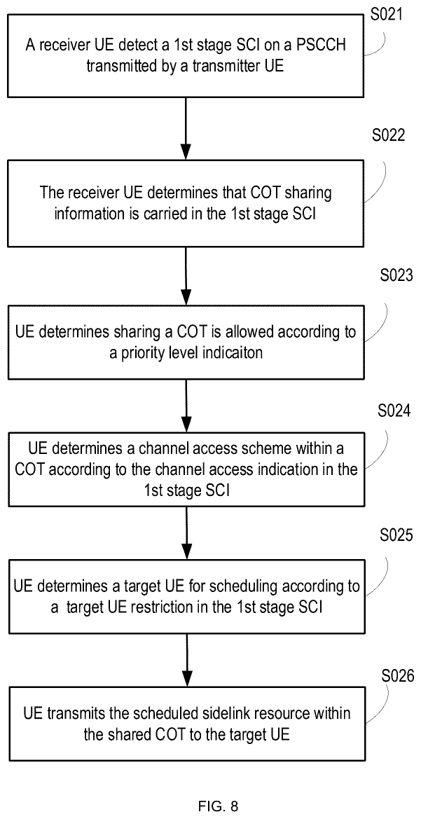

With reference to FIG. 8, an example procedure for processing a 1st stage SCI by a receiver UE is provided in the following.
A receiver UE detects a 1^{st} stage SCI on PSCCH transmitted from a transmitter UE (S021).
The receiver UE determines that a COT sharing information is carried in the 1^{st} stage SCI (S022).
The receiver UE determines that sharing a COT is allowed according to a sharing priority level indication in the 1^{st} stage SCI (S023).
The receiver UE determines a channel access scheme within the COT according to channel access indication in the 1^{st} stage SCI (S024).
The receiver UE determines a target UE for scheduling a sidelink resource according to the target UE restriction (S025).
The receiver UE performs sidelink transmission over the scheduled sidelink resource to the target UE within the shared COT (S026).

### Embodiment D

SCI monitoring schemes for a responder UE to share other UE's COT are detailed in the following:

A responder UE monitors one or more of the following information to determine available or valid resource(s) for SL transmission: resource reservation information, COT sharing information, FFP parameters, and a priority level indication.
Resource reservation information:
   The responder UE refrains from using resource(s) reserved by the initiator UE within a COT. The resource reservation information shows the resource(s) reserved by the initiator UE.
COT sharing information:
   The responder UE monitors the COT sharing information to determine whether COT sharing is enabled and determines a time and frequency domain range for COT sharing.
FFP parameters:
   For FBE-based channel access, the responder UE should avoid using a resource within an idle period of an FFP.
A priority level indication:
   A UE may refrain from using a COT initiated by the initiator UE if having a priority level lower than a priority level indicated by the priority level indication.

A responder UE monitors at least one of the following information in SCI to determine a channel access scheme for sharing a COT initiated by one of other UEs.
Parameters of LBT type, CPE length or CAPC used for responder UE; and
An indication of a CAPC used by the initiator UE.
   Responder UE may use the same or smaller CAPC for channel access.

In addition to sharing other UE's COT, the responder UE can forward COT sharing information to another UE (e.g., a second UE) in case the second UE cannot directly receive the COT sharing information from the initiator UE.

Other schemes or supporting parameters for the responder UE sharing other UE's COT can be referred to Embodiment A-3 and Embodiment C.

With reference to FIG. 3, as illustrated in embodiment D, the COT sharing information may include a CAPC value adopted by the first UE. The COT sharing information may include a priority level or a UE identifier (ID) to indicate a qualified UE for using the shared COT. The second UE determines to use the shared COT if a priority level of traffic for the second burst transmission is equal or larger than the priority level in the COT sharing information. The second UE is qualified to use the shared COT if the CAPC value of the second UE is equal or less than the CAPC value adopted by the first UE. The second UE determines to use the shared COT if the CAPC value of the second UE is equal or less than the CAPC value adopted by the first UE.

With reference to FIG. 3, as illustrated in embodiment D, the COT sharing information may include an indication of whether the second UE is able to forward the at least one of the COT sharing information to a third UE.

With reference to FIG. 4, as illustrated in embodiment D, the COT sharing information may include a CAPC value adopted by the first UE initiating the COT.

With reference to FIG. 4, as illustrated in embodiment D, the second UE is allowed to use the shared COT if the CAPC value of the second UE is equal or less than the CAPC value adopted by the first UE. The COT sharing information includes a priority level indication, the second UE is allowed to use the shared COT if a priority level of the second UE is higher than a priority level indicated by the priority level indication.

### Embodiment E

A resource reservation scheme in the scenario of COT sharing is detailed in the following.

A transmitter UE can schedule one or more than one group (or burst) of consecutive PSSCH resources for transmitting one or more than one TBs within a COT or across COTs using a single SCI. The reserved PSSCH resources can be used for retransmitting a TB or transmitting new TB.
The resource of one or more than one group of consecutive PSSCHs can be reserved and indicated in the 1st stage SCI.
   The reserved resource in the frequency domain can be indicated using a BWP index, subband index, or interlace index.
   The reserved resource in the time domain can be indicated using, e.g.,
      A TDRA table;
      An offset value relative to a frame/slot boundary;
      A period of sidelink transmission; and/or
      A duration of sidelink transmission.
   The reserved resource across a COT for FBE-based channel access can be indicated based on, e.g.,
      An FFP index and an offset value relative to an FFP boundary; and/or
      A slot index and an offset value relative to the slot boundary of PSCCH.
If the reserved resource is outside of the COT, the transmitter UE needs to initiate a COT before accessing the reserved resource.

The resource reserved by a scheduling UE can also be used by other UEs in addition to the scheduling UE.
Information of whether the reserved resource can be used for SL transmission by the scheduling UE, the scheduled UE, or a specific group of UE can be derived based on an indication in the SCI or based on whether the reserved resource is within the COT shared by the scheduling UE.
   An indication in the SCI:
      The indication in SCI can be jointly encoded with COT sharing information, resource reservation information, or HARQ-ACK feedback indication. The HARQ-ACK feedback indication indicates whether HARQ-ACK feedback of sidelink transmission is required.
   Whether the reserved resource is within the COT shared by the scheduling UE:
      For example, if the reserved resource is overlapped with a region of shared COT, then the reserved resource can be used by another UE, e.g., scheduled UE. Otherwise, the reserved resource is at least used by the scheduling UE.

The resource reserved by a scheduling UE can be used for transmitting HARQ-ACK feedback in PSFCH from a scheduled UE.
The resource reserved for transmitting HARQ-ACK feedback can be within or outside of the COT initiated by a transmitter UE.
   A specific LBT type, CPE length, or CAPC may be assumed for PSFCH transmission or can be indicated by transmitter UE in the SCI.
   If the reserved resource is outside of the COT, then the receiver UE needs to initiate a COT before accessing the reserved resource for PSFCH transmission.
An indication of using reserved resources for HARQ-ACK feedback transmission or other SL transmissions other than HARQ-ACK feedback can be indicated in SCI.
   E.g., The indication can be jointly encoded with resource reservation information.
Scheduling UE can reselect a resource for an update of resource reservation in response to the received HARQ-ACK feedback.
The PSFCH resource can be implicitly reserved based on a corresponding resource mapping between PSSCH/PSCCH and PSFCH.

A scheduling UE should perform channel access (e.g., Type 1/2A/2B/2C LBT) depending on whether the reserved resource is in-COT or out-of-COT before accessing the reserved resource.
If a second UE shares the scheduling UE's COT and declares its own resource reservation information in the second UE's SCI, the scheduling UE should monitor the second UE's resource reservation information in SCI before performing channel access.
   After SCI monitoring by the scheduling UE: If the resource reserved by the second UE overlapped with the resource reserved by the scheduling UE, and if the second UE has a higher priority level than the scheduling UE, the scheduling UE may refrain from performing channel access to access its reserved resource.
   On the contrary, the second UE cannot reserve a resource overlapped with the initiator UE's reserved resource if the second UE has a lower priority than the scheduling UE, the scheduling UE can perform channel access to access its reserved resource.
Upon successful channel access to access previously reserved resource. The scheduling UE can transmit an SCI during a previously reserved resource, wherein the SCI further carriers information of another reserved resource for future transmission, i.e., the resource reservation indication in SCI can be a cascaded structure over each previously reserve resource.
   In this case, the initiator UE may reserve a resource at another COT, i.e., inter-COT resource reservation. The UE needs to initiate another COT covering the reserved resource if other UEs have not yet initiated a COT covering the same reserved resource.

For a UE, e.g., a responder UE, scheduled UE, or a receiver UE, in addition to monitoring the resource reservation information transmitted by a scheduling UE, the UE can perform one or more the following:
Forwarding the resource reservation information to a third UE in case the third UE cannot receive the resource reservation information directly from the scheduling UE; and
Reserving its own resource on the SCI, excluding the resource already reserved by the scheduling UE.

With reference to FIG. 4, as illustrated in embodiment E, the second UE is a qualified UE for using the shared COT if a target UE of the second SL burst at least includes the first UE. The second UE is a qualified UE for using the shared COT if the second SL burst is transmitted within a resource reserved by the first UE in the COT.

### Embodiment E-1

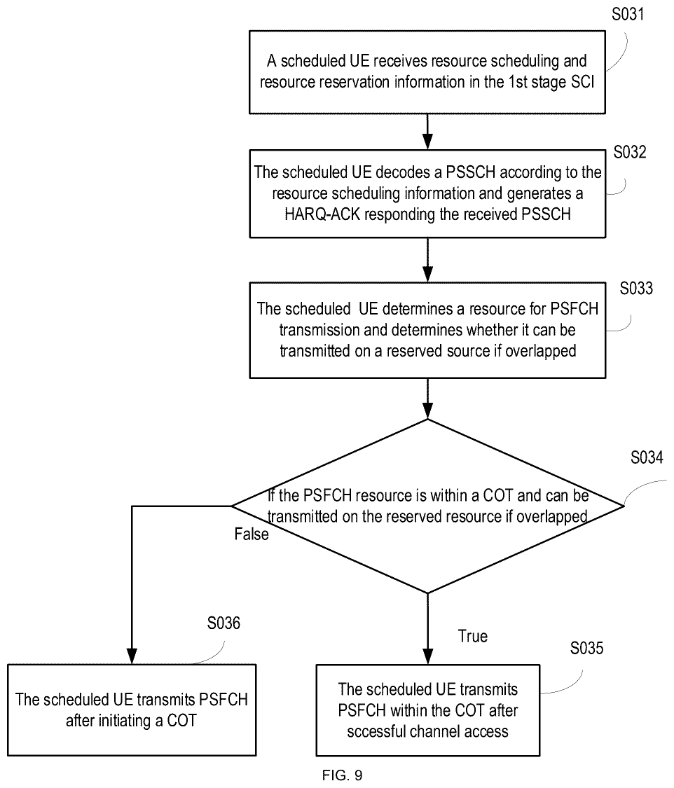

With reference to FIG. 9, an example procedure for resource reservation scheme operating with COT sharing is detailed in the following.
A scheduled UE receives a 1^{st} stage SCI with resource scheduling information and resource reservation information on PSCCH transmitted from a transmitter UE (S031).
The scheduled UE receives a PSSCH, decodes the PSSCH according to the scheduling information and the 2^{nd} stage SCI in the PSSCH, and generates a HARQ-ACK responding to the received PSSCH (S032).
The scheduled UE determines the resource used for PSFCH transmission and determines whether the reserved resource can be used for HARQ-ACK transmission in the PSFCH if the reserved resource is overlapped with the PSFCH resource (S033)
If the PSFCH resource is within a COT according to a COT sharing information, or the PSFCH resource is allowed to be transmitted in a resource overlapped with a reserved resource within the COT (S034), the scheduled UE transmits the PSFCH after successful channel access within the COT (S035).
Otherwise, if the PSFCH resource is outside of the COT shared by the scheduling UE, the scheduled UE initiates a COT before accessing the PSFCH resource (S036).

### Embodiment F

Resource selection schemes for Mode 2 resource allocation are detailed in the following:

In selecting or reserving an available resource for SL transmission, a UE may exclude non-available resources using at least one of the following information:
COT sharing information;
Resource reservation information; and
An IDLE period of an FFP for FBE-based channel access.

The UE can randomly select one or more than one available frequency domain resource using an index of
an interlace, subband, RB, or BWP.

The UE can select one or more than one available time domain resource with a random starting time at different slots.

### Embodiment G

A scheme of accessing a reserved resource by an initiator UE is detailed in the following, wherein the resource is previously reserved by the initiator UE.

For an initiator UE that has initiated a COT and also reserved a resource for future transmission, the following applies.
For the reserved resource being outside of a current COT initiated by the initiator UE:
   The initiator UE needs to initiate another COT covering the reserved resource based on Type 1 LBT for accessing the reserved resource if a COT covering the reserved resource has not yet been initiated by other UEs.
      When the initiator UE detects resource reservation information by a second UE, and the resource reserved by the second UE is overlapped with the resource reserved by the initiator UE: According to the priority level indicated in the SCI of the second UE, if the second UE has a higher priority level than the initiator UE, the initiator UE may refrain from initiating a COT for accessing its reserved resource.
For the reserved resource being within a COT initiated by the initiator UE:
   When the initiator UE detects resource reservation information from another UE with higher priority reserving a resource overlapping with the resource reserved by the initiator UE
      The initiator UE may refrain from performing channel access and accessing its reserved resource within the COT.
   When no other UE with higher priority reserves a resource overlapping with the resource reserved by the initiator UE,
      The Initiator UE can transmit directly without LBT on the reserved sidelink resource if the transmission gap before the reserved resource is at most 16 us.
      The initiator UE can transmit after channel access, e.g., Type 2, on the reserved sidelink resource if the transmission gap before the reserved resource is larger than 16 us or 25 us.

### Embodiment G-1

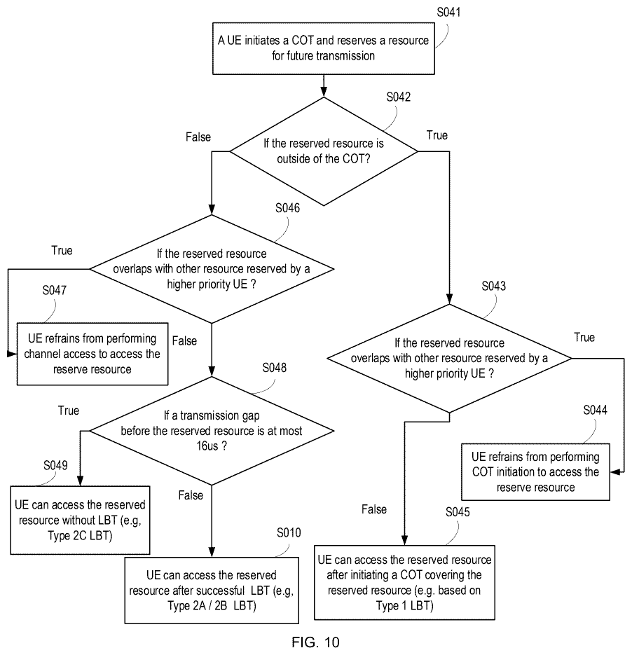

With reference to FIG. 10, an example of a procedure of accessing a reserved resource by an initiator UE is detailed in the following, wherein the resource is previously reserved by the initiator UE.
An initiator UE initiates a COT and reserves a resource for future transmission (S041).
If the reserved resource is outside of the COT initiated by the initiator UE (S042), and if there is no other UE with higher priority reserving another resource overlapped with the resource reserved by the initiator UE (S043), the initiator UE initiates a COT covering the reserved resource to access the reserved resource, e.g., through Type 1 LBT (S045).
Otherwise, the initiator UE refrains from initiating a COT to access the reserved resource (S044).
If the reserved resource is within the COT initiated by the initiator UE (S042), and if there is no other UE with higher priority reserving another resource overlapped with the resource reserved by the initiator UE (S046), the Initiator UE can transmit directly on the reserved resource without LBT (S049) if transmission gap before the reserved resource is at most 16 us (S048), or access the reserve resource after successful channel access (e.g., Type 2A/2B LBT) if transmission gap before the reserved resource is larger than 16 us or 25 us (S010).
Otherwise, the initiator UE refrains from accessing a reserved resource (S047).

With reference to FIG. 3, as illustrated in embodiment A-1 and G, a LBT type determined based on type of SL channel in the second SL burst or width of transmission gap before the second SL burst can be used by the second UE to perform channel access for transmitting the second SL burst within the shared COT, wherein the specific LBT type includes Type 2A, Type 2B, or Type 2C.

### Embodiment H

A scheme of accessing a reserved resource by a responder UE is detailed in the following, wherein the resource is previously reserved by an initiator UE.
If the reserved resource is within a COT initiated by the initiator UE, and the responder UE detects that no other UE with higher priority reserves a resource overlapping with the resource reserved by the initiator UE.
   The responder UE shares a COT with an initiator UE can transmit directly on the reserved sidelink resource without LBT if at least one following condition is satisfied:
      The initiator UE schedule a resource for feedback transmission within the reserved resource.
         One or more than one feedback of transmitted PSSCH(s) can be transmitted in the same reserved resource.
      The responder UE receives a feedback request in the SCI.
      The transmission gap before the reserved resource is at most 16 us.
   The responder UE shares a COT initiated by an initiator UE can perform sidelink transmission on the reserved sidelink resource after channel access if at least one following condition is satisfied:
      The initiator UE schedule a resource for feedback transmission within the reserved resource.
         One or more than one feedback of transmitted PSSCH(s) can be transmitted in the same reserved resource.
      The responder UE receives a feedback request in the SCI.
      The transmission gap before the reserved resource is larger than 16 us or 25 us.
Otherwise, the responder UE refrains from performing channel access to access the reserved resource.
If the reserved resource is outside of a current COT, and there is no other UE with higher priority reserves a resource overlapping with the resource reserved by initiator UE, the responder UE needs to initiate another COT covering the reserved resource to access the reserved resource if a COT covering the reserved resource has not yet been initiated by other UEs.
Otherwise, the responder UE refrains from initiating a COT to access the reserved resource.

### Embodiment I

Any schemes, options, and examples in each of embodiments, either for COT sharing or for resource reservation can be adopted to work together using various combinations for different purposes. In the above embodiments, depending on the selected use case, the terms transmitting UE, transmitter UE, initiator UE, and scheduling UE can be interchangeably used. Similarly, the terms receiving UE, receiver UE, responder UE, and scheduled UE can be interchangeably used.

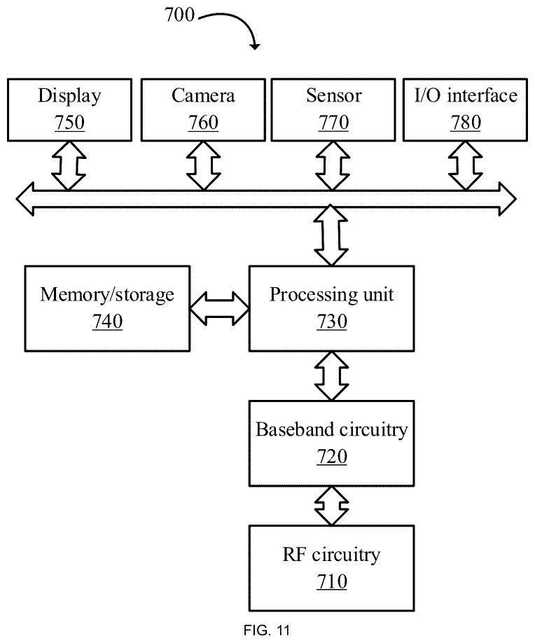

FIG. 11 is a block diagram of an example system 700 for wireless communication according to an embodiment of the present disclosure. Embodiments described herein may be implemented into the system using any suitably configured hardware and/or software. FIG. 11 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or the gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described function. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for the system. The memory/storage for one embodiment may include any combination of suitable volatile memory, such as dynamic random-access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that may be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure may be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments may be integrated into one processing unit, physically independent, or integrated into one processing unit with two or more than two units.

If the software function unit is realized and used and sold as a product, it may be stored in a readable storage medium in a computer. Based on this understanding, the technical plan proposed by the present disclosure may be essentially or partially realized as the form of a software product. Or one part of the technical plan beneficial to the conventional technology may be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random-access memory (RAM), a floppy disk, or other kinds of media capable of storing program codes.

Embodiments of the disclosure may be applied to HARQ-ACK feedback for URLLC or IIoT to reduce SPS PDSCH feedback latency and enhance HARQ-ACK transmission reliability.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method for execution by a first user equipment (UE), comprising:
performing channel occupancy time (COT) initiating to initiate a COT based on a channel access scheme;
generating COT sharing information for sharing the COT to a second UE;
providing the COT sharing information to the second UE through a transmission of a first sidelink (SL) burst; and
receiving from the second UE a second sidelink (SL) burst within the shared COT;
wherein the first SL burst or the second SL burst includes more than one SL transmissions.

2. The wireless communication method of claim 1, wherein a LBT type determined based on type of SL channel in the second SL burst or width of transmission gap before the second SL burst is used by the second UE to perform channel access for transmitting the second SL burst within the shared COT; wherein the LBT type includes Type 2A, Type 2B, or Type 2C.

3. (canceled)

4. The wireless communication method of claim 1, wherein the channel access scheme is a Type 1 channel access with respect to a channel access priority class (CAPC) value or a cyclic prefix extension (CPE), the Type 1 channel access is operated over one of more than one starting position within a slot for the first SL burst transmission.

5. The wireless communication method of claim 4, wherein the location of the more than one starting position is pre-configured per SL BWP.

6. The wireless communication method of claim 4, wherein more than one CAPC value is pre-configured for the first UE, and one of the more than one CAPC value is selected by the first UE according to a quality identifier of a traffic service type or the type of a SL channel transmitted by the first UE.

7. The wireless communication method of claim 6, wherein one CAPC value is pre-determined for PSFCH transmission by the first UE.

8. The wireless communication method of claim 4, wherein more than one CPE value is pre-configured for the first UE, and one of more than one CPE value is selected by the first UE to adjust a starting point for transmitting the first SL burst, and the selection of the CPE value is based on a priority level of a SL channel transmitted by the first UE.

9. The wireless communication method of claim 8, wherein one CPE value is pre-determined for PSFCH transmission by the first UE.

10. The wireless communication method of claim 4, wherein the first UE performs the Type 1 channel access within a sub-band with resource block (RB) granularity in a SL bandwidth part (BWP).

11. The wireless communication method of claim 1, wherein the COT sharing information is carried in sidelink channel information (SCI) with a preconfigured SCI format.

12. The wireless communication method of claim 1 wherein at least part of the COT sharing information is carried in the physical sidelink shared channel (PSSCH).

13. The wireless communication method of claim 1, wherein the COT sharing information includes a time domain COT sharing indication that indicates a starting location and an ending slot location, wherein the starting location for COT sharing is determined based on an offset relative to an ending point of a slot carrying the SCI within the COT.

14. (canceled)

15. The wireless communication method of claim 1, wherein the COT sharing information includes a CAPC value adopted by the first UE initiating the COT.

16. The wireless communication method of claim 15, wherein the second UE is allowed to use the shared COT if the CAPC value of the second UE is equal or less than the CAPC value adopted by the first UE.

17-19. (canceled)

20. The wireless communication method of claim 1, wherein the second UE is a qualified UE for using the shared COT if a target UE of the second SL burst includes at least the first UE.

21. (canceled)

22. The wireless communication method of claim 1, wherein the COT sharing information includes UE identity information, the UE identity information includes information of one or more than one UE which is qualified for using the shared COT.

23. The wireless communication method of claim 22 wherein the UE identity information includes a source ID that represents the first UE initiating the COT, a destination ID that represents one or more than one target UE of the first UE, or an ID indicating at least one qualified UE for using the shared COT.

24. The wireless communication method of claim 1, wherein the COT sharing information includes an indication in the 1^{st} stage SCI to indicate whether COT sharing is enabled.

25. The wireless communication method of claim 24, wherein a field of time domain COT sharing information is provided in the 2^{nd} stage SCI if COT sharing is enabled.

26-31. (canceled)

32. A wireless communication method for execution by a user equipment (UE), comprising:
receiving, through a first sidelink (SL) burst, COT sharing information that indicates a shared COT initiated by a first UE;
operating as a second UE for transmitting to the first UE a second sidelink (SL) burst within the shared COT;
wherein the first SL burst or the second SL burst includes more than one SL transmissions.

33-56. (canceled)
